(19) United States
(12) Patent Application Publication
(10) Pub. No.: US 2018/0086118 A1
(43) Pub. Date: Mar. 29, 2018

(54) PRINTING APPARATUS

(71) Applicant: SEIKO EPSON CORPORATION, Tokyo (JP)

(72) Inventor: Yoshihiro WATANABE, Shiojiri-shi (JP)

(21) Appl. No.: 15/718,358

(22) Filed: Sep. 28, 2017

(30) Foreign Application Priority Data
Sep. 29, 2016 (JP) 2016-190900

(51) Int. Cl. B41J 15/04; B41J 2/01; B41J 2/05

(52) U.S. Cl. CPC B41J 15/04; B41J 2/05; B41J 2/01

(57) ABSTRACT

A printing apparatus includes a printing mechanism that executes printing on a medium, a support member that supports a roll core around which the medium printed by the printing mechanism is wound, and a moving mechanism that moves the support member to a plurality of positions different from each other in height in a vertical direction.

### BACKGROUND

### 1. Technical Field

The present invention relates to a printing apparatus.

### 2. Related Art

Printing apparatuses configured to take up a printed medium around a roll core have recently been proposed. JP-A-2012-166915 discloses a lifting device for transporting a rolled medium, in other words the medium printed by a printing mechanism and wound around the roll core. The lifting device is configured to bring down the rolled medium removed from the printing apparatus. Then an operator can move the lifting device so as to transport the rolled medium to a desired location.

With the technique according to JP-A-2012-166915, the roll core around which the printed medium is wound is installed at a predetermined fixed position downstream of the printing mechanism. Such a position of the roll core is not necessarily appropriate from the viewpoint of the convenience of various works, for example fixing the leading end of a medium to an unused roll core, and removing the rolled medium that has undergone the printing operation, from the printing apparatus for transportation. Thus, the works related to the roll cores, both unused and used ones, are unable to be smoothly performed.

### SUMMARY

An advantage of some aspects of the invention is facilitation of various works related to the roll core for taking up the medium.

In a first aspect, the invention provides a printing apparatus including a printing mechanism that executes printing on a medium, a support member that supports a roll core around which the medium printed by the printing mechanism is wound, and a moving mechanism that moves the support member to a plurality of positions different from each other in height in a vertical direction. With the mentioned configuration, the support member can be moved to the plurality of positions with the roll core supported thereon. Therefore, the roll core can be moved to such positions that are appropriate for performing various works related to the roll core (both unused one and one with the printed medium wound therearound).

In a second aspect, the printing apparatus according to the first aspect may further include a medium outlet located downstream of the printing mechanism in a transport direction of the medium, and formed so as to contact the medium. The moving mechanism may be configured to move the support member to a first position where the roll core is located at a position lower than the medium outlet, and to a second position higher than the first position. With the mentioned configuration, the support member can be moved to the first position where the roll core is located at the position lower than the medium outlet, and to the second position where the roll core is located at a position higher than the first position. Therefore, for example, the medium can be fixed onto the roll core when the support member is at the second position, and the printing may be executed by the printing mechanism when the support member is at the first position.

In a third aspect, the moving mechanism of the printing apparatus according to the second aspect may move the support member to a third position between the first position and the second position in a path along which the moving mechanism moves the support member, the third position being located on an opposite side of the printing mechanism with respect to a straight line drawn between the first position and the second position, in a view in a direction parallel to a central axis of the roll core. With the mentioned configuration, the support member can be moved to the third position on the opposite side of the printing mechanism with respect to the straight line drawn between the first position and the second position. Therefore, the roll core or the medium wound on the roll core can be prevented from colliding with the medium outlet, while being moved by the moving mechanism.

In a fourth aspect, the support member of the printing apparatus according to any one of the first to the third aspects may include a support shaft extending in a width direction of the medium, and a first mounting guide and a second mounting guide attached to the support shaft. The first mounting guide and the second mounting guide may support respective end portions of the roll core, and the support shaft may be located at a position other than right under the roll core. In the mentioned configuration in which the first mounting guide and the second mounting guide support the respective end portions of the roll core, the support shaft supporting the first mounting guide and the second mounting guide is located at a position other than right under the roll core. Therefore, the printed rolled medium, in other words the printed medium wound around the roll core, can be easily transported using a transport device such as a handcart located under the roll core.

In a fifth aspect, the invention provides a using method of the printing apparatus according to the second or third aspect. The method includes fixing an end portion of the medium to the roll core after causing the moving mechanism to move the support member to the second position, causing the moving mechanism to move the support member to the first position after the medium is fixed to the roll core, and causing the printing mechanism to execute printing. With the mentioned arrangement, the end portion of the medium is fixed to the roll core when the support member is at the second position. Therefore, the work to fix the end portion of the medium to the roll core can be more easily performed, compared with the case of fixing the end portion of the medium to the roll core when the support member is at the first position. In addition, the printing mechanism is activated when the support member is at the first position, which provides an additional advantage in that the space under the printing mechanism can be effectively utilized to store the printed medium.

In a sixth aspect, the invention provides a using method of the printing apparatus according to the third aspect. The method includes fixing the end portion of the medium to the roll core after causing the moving mechanism to move the support member to the second position, causing the moving mechanism to move the support member to the first position after the medium is fixed to the roll core, causing the printing mechanism to execute printing, and mounting or removing the roll core on or from the support member, after causing the moving mechanism to move the support member to the third position. With the mentioned arrangement, the end portion of the medium is fixed to the roll core when the support member is at the second position. Therefore, the work to fix the end portion of the medium to the roll core can be more easily performed, compared with the case of fixing the end portion of the medium to the roll core when the support member is at the first position. In addition, the printing mechanism is activated when the support member is at the first position, which provides an additional advantage in that the space under the printing mechanism can be effectively utilized to store the printed medium. Here, the first position may be too low to mount or remove the roll core on or from the support member. Likewise, the second position may be too high to mount or remove the roll core on or from the support member. Therefore, the mentioned arrangement of setting the support member at the third position when the roll core is mounted or removed on or from the support member facilitates the mounting or removing work.

### BRIEF DESCRIPTION OF THE DRAWINGS

The invention will be described with reference to the accompanying drawings, wherein like numbers reference like elements.

FIG. 1 includes a front view and side views of a printing apparatus according to a first embodiment.

FIG. 2 is a side view showing a state in which a support member is located at a position P2.

FIG. 3 is a side view showing a state in which the support member is located at a position P3.

FIG. 4 is a flowchart showing how to use the printing apparatus.

FIG. 5 includes a front view and side views of a printing apparatus according to a second embodiment.

FIG. 6 is a side view showing a state in which the support member is located at the position P2.

FIG. 7 is a side view showing a state in which the support member is located at the position P3.

FIG. 8 is a side view of a printing apparatus according to a third embodiment.

FIG. 9 is a side view showing a variation of the printing apparatus.

### DESCRIPTION OF EXEMPLARY EMBODIMENT

### First Embodiment

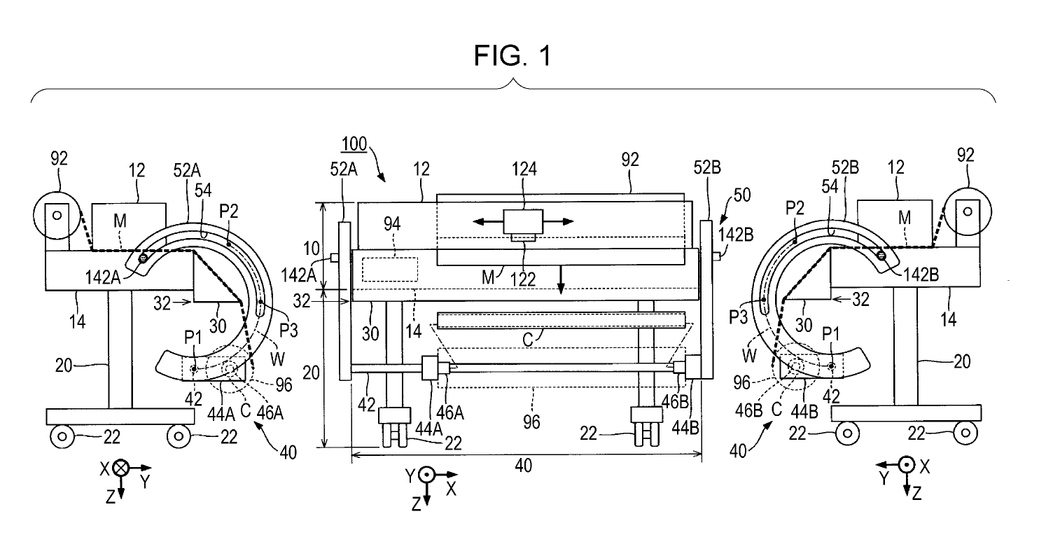

FIG. 1 includes a front view and side views of a printing apparatus according to a first embodiment of the invention. The printing apparatus 100 according to the first embodiment is a liquid ejecting apparatus that ejects ink, exemplifying the liquid in the invention, onto a medium M through a plurality of nozzles, to thereby print an image on the medium M. As shown in FIG. 1, a rolled medium including an unused medium M wound around a roll core (hereinafter, unprinted rolled medium 92) is mounted on the printing apparatus 100. The medium M is typically exemplified by a printing sheet, however any desired printing material, for example a resin film or a fabric, may be employed as the medium M. The printing apparatus 100 according to the first embodiment is a large format printer (LFP) capable of executing the printing on a medium M having a width of, for example, 64 inches.

As shown in FIG. 1, the printing apparatus 100 includes a printing mechanism 10, legs 20, a heater 30, a support member 40, and a moving mechanism 50. The printing mechanism 10 is an elongate structure extending in an X-direction corresponding to the width direction of the medium M. A liquid container 94 for storing different types of inks is mounted on the printing mechanism 10, in addition to the unprinted rolled medium 92. The legs 20 serve to support the printing mechanism 10 at a predetermined height. The legs 20 each include carrying wheels 22 attached to the bottom portion. In the following description, a vertical direction (up-down direction) will be referred to as Z-direction, and a direction perpendicular to an X-Z plane (front-back direction of the printing apparatus 100 will be referred to as Y-direction.

The medium M is supplied to the printing mechanism 10 from the unprinted rolled medium 92. The printing mechanism 10, configured to execute the printing on the medium M supplied from the unprinted rolled medium 92, includes a printing unit 12 and a main body 14. The printing unit 12 is mounted on the upper face of the main body 14. The main body 14 includes a platen on which the medium M is mounted, and a non-illustrated transport mechanism that transports the medium M in the Y-direction.

The printing unit 12 includes a liquid ejecting head 122 and a transport member (carriage) 124. The liquid ejecting head 122 is an ink jet head that ejects the ink supplied from the liquid container 94 onto the medium M through the plurality of nozzles, under control of a non-illustrated controller. More specifically, the liquid ejecting head 122 includes pressure chambers and piezoelectric elements respectively corresponding to the plurality of nozzles, and is configured to eject the ink loaded in the pressure chamber through the corresponding nozzle, by supplying drive signals to drive the piezoelectric element thereby changing the pressure in the pressure chamber. Here, a thermal type liquid ejecting head 122 having a heating element, configured to heat the pressure chamber to generate air bubbles therein so as to change the pressure in the pressure chamber, may also be employed. The transport member 124, which serves to accommodate and support the liquid ejecting head 122, is configured to repeatedly reciprocate in the X-direction, by being driven by a non-illustrated drive mechanism including a transport belt, a motor, and so forth. The liquid ejecting head 122 ejects the ink onto the medium M in concurrence with the transportation of the medium M and the reciprocation of the transport member 124, to thereby print an image on the surface of the medium M.

The heater 30 is, for example, an after heater that generates heat using a heat source such as a heating wire, and serves to expedite the drying of the ink, by heating the medium M printed by the printing mechanism 10. As shown in FIG. 1, the heater 30 according to the first embodiment is fixed to the main body 14 of the printing mechanism 10. More specifically, the heater 30 (exemplifying the medium outlet in the invention) is located downstream of the printing mechanism 10 in the transport direction of the medium M (plus side in the Y-direction), and makes contact with the printed medium M.

The support member 40 is configured to support a roll core C around which the medium M printed by the printing mechanism 10 is to be wound. The roll core C is a circular tube for taking up the printed medium M in a roll, and is formed of paper, plastic, or a similar material. The support member 40 according to the first embodiment may also be construed as a structure for supporting the medium M printed and wound around the roll core C (hereinafter, printed rolled medium 96). The support member 40 removably supports the roll core C. The moving mechanism 50 is configured to support, as well as move, the support member 40. More specifically, the moving mechanism 50 according to the first embodiment is manually operated by a user, so as to move the support member 40. Here, the moving mechanism 50 may be driven by a force supplied from a drive source such as a motor, to move the support member 40.

The support member 40 according to the first embodiment includes a support shaft 42, a mounting guide 44A (exemplifying the first mounting guide in the invention), and a mounting guide 44B (exemplifying the second mounting guide in the invention). The support shaft 42 is a bar-shaped member having a circular cross-section and extending over the entire length of the printing apparatus 100, longer than the transverse width (size in the X-direction) of the printing mechanism 10. The moving mechanism 50 supports the support member 40 such that the support shaft 42 extends in the X-direction. The mounting guide 44A and the mounting guide 44B are attached to the support shaft 42. To be more detailed, the mounting guide 44A and the mounting guide 44B are supported by the support shaft 42 with a spacing therebetween in the X-direction. The position of the mounting guide 44B on the support shaft 42 in the X-direction is fixed. In contrast, the mounting guide 44A is movable along the support shaft 42. Thus, the spacing between the mounting guide 44A and the mounting guide 44B is variable depending on the position of the mounting guide 44A in the X-direction. Here, both of the mounting guide 44A and the mounting guide 44B may be set to move along the support shaft 42.

The mounting guide 44A includes a protruding portion 46A formed on a surface thereof opposing the mounting guide 44B (surface on the plus side in the X-direction), so as to protrude in the X-direction. Likewise, the mounting guide 44B includes a protruding portion 46B formed on a surface thereof opposing the mounting guide 44A (surface on the minus side in the X-direction), so as to protrude in the X-direction. The protruding portion 46A and the protruding portion 46B each have an outer diameter equal to or slightly larger than the inner diameter of the roll core C. The roll core C is retained by the protruding portion 46A and the protruding portion 46B. To be more detailed, the protruding portion 46A is inserted in an opening formed in an end portion of the roll core C on the minus side in the X-direction, and the protruding portion 46B is inserted in an opening formed in the other end portion of the roll core C on the plus side in the X-direction. The user can adjust the spacing between the mounting guide 44A and the mounting guide 44B can be adjusted according to the length of the roll core C (or sheet width of the medium M) as desired, by moving the mounting guide 44A along the support shaft 42. Therefore, a plurality of types of roll cores C, different in length from each other, can be supported by the support member 40.

As shown in FIG. 1, the protruding portion 46A and the protruding portion 46B are located on the plus side in the Y-direction, in a view from the support shaft 42. In other words, the support shaft 42 is located on the minus side in the Y-direction (rear side of the printing apparatus 100), in a view from the roll core C supported by the support member 40. In the case where, for example, the support shaft 42 is located right under the roll core C, the support shaft 42 may disturb a transport device, such as a handcart for transporting the printed rolled medium 96, from being brought to a position under the printed rolled medium 96. In the first embodiment, however, since the support shaft 42 is located on the minus side in the Y-direction in a view from the roll core C, the transport device for transporting the printed rolled medium 96 can be smoothly brought to the position under the printed rolled medium 96, which leads to reduced burden in the transportation work of the printed rolled medium 96. From the viewpoint of attaining the foregoing advantages, the position of the support shaft 42 is not limited to the minus side in the Y-direction viewed from the roll core C. For example, the support shaft 42 may be located on the plus side in the Y-direction or on the minus side in the Z-direction, in a view from the roll core C. In other words, it is preferable to locate the support shaft 42 in a position other than right under the roll core C. In particular, locating the support shaft 42 on the rear side of the roll core C as in the first embodiment facilitates the roll core C to be mounted or removed on or from the support member 40, compared with the case of locating the support shaft 42 on the plus side in the Y-direction in a view from the roll core C (front side of the printing apparatus 100).

As shown in FIG. 1, the moving mechanism 50 according to the first embodiment includes a retaining arm 52A and a retaining arm 52B. Each of the retaining arm 52A and the retaining arm 52B is a plate-shaped member generally formed in an arcuate shape. The retaining arm 52A is mounted on the printing mechanism 10 on the minus side in the X-direction, and the retaining arm 52B is mounted on the printing mechanism 10 on the plus side in the X-direction. An end portion of the support shaft 42 of the support member 40 on the minus side in the X-direction is supported by the retaining arm 52A, and the other end portion of the support shaft 42 on the plus side in the X-direction is supported by the retaining arm 52B.

The retaining arm 52A and the retaining arm 52B each include a guide groove 54 extending in an arcuate shape along the outer shape of the retaining arm. A protruding portion 142A, formed on the main body 14 so as to protrude from the side face on the minus side in the X-direction, is inserted in the guide groove 54 of the retaining arm 52A, and a protruding portion 142B, formed on the main body 14 so as to protrude from the side face on the plus side in the X-direction, is inserted in the guide groove 54 of the retaining arm 52B. With the foregoing configuration, the moving mechanism 50 (retaining arm 52A and the retaining arm 52B) can be moved by the user, with the protruding portion 142A and the protruding portion 142B engaged with the guide groove 54. In other words, the retaining arm 52A and the retaining arm 52B are rotated about an axial line in the X-direction passing the center of curvature of the guide groove 54. When the moving mechanism 50 is rotated as described above, the support member 40 moves along an arcuate track W about an axial line parallel to the X-direction. Thus, the moving mechanism 50 moves the support member 40 along the track W. Here, the moving mechanism 50 is supported by the printing apparatus 100 (e.g., printing mechanism 10 or leg portion 20) via a non-illustrated support member, so as to move along the track W.

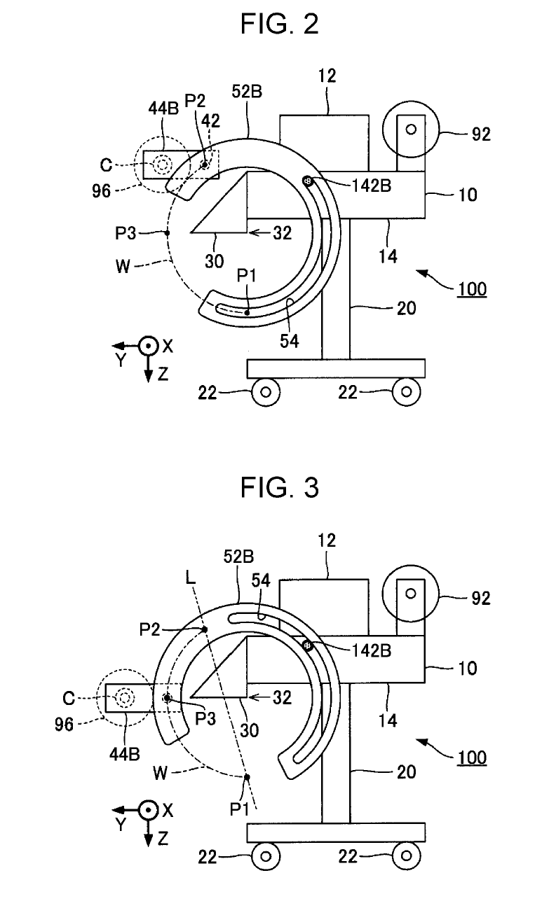

The moving mechanism 50 according to the first embodiment is configured to move the support member 40 to a plurality of positions different from each other in height in the vertical direction (Z-direction). More specifically, the support member 40 can be moved to a position P1, a position P2, and a position P3 along the track W. FIG. 1 illustrates a state in which the support member 40 (support shaft 42) is located at the position P1 (exemplifying the first position in the invention). FIG. 2 illustrates a state in which the support member 40 (support shaft 42) is located at the position P2 (exemplifying the second position in the invention), and FIG. 3 illustrates a state in which the support member 40 (support shaft 42) is located at the position P3 (exemplifying the third position in the invention). The moving mechanism 50 moves the support member 40 between the position P1 and the position P2, along the track W.

As shown in FIG. 1, when the support member 40 is at the position P1, the roll core C is located at a position lower than the heater 30. In contrast, the position P2 shown in FIG. 2 is higher than the position P1. To be more detailed, when the support member 40 is at the position P2, the central axis of the roll core C is located at a position higher than a lower face 32 of the heater 30 in the Z-direction (vertical direction). In this embodiment, the position P2 is the highest position in the track W along which the support member 40 can move, and the closest position to the printing mechanism 10 (in particular, printing unit 12).

The position P3 shown in FIG. 3 is located between the position P1 and the position P2 along the track W. In other words, the position P3 is located between the position P1 and the position P2 in the Z-direction. As stated above, the track W has an arcuate shape. Accordingly, the position P3 is located on the opposite side of the printing mechanism 10 with respect to a straight line L drawn between the position P1 and the position P2, in a view in a direction parallel to the central axis of the roll core C, as shown in FIG. 3. Therefore, when the support member 40 moves from one of the position P1 and the position P2 to the other, the support member 40 passes the position P3 spaced from the straight line L, so as to avoid (circumvent) the heater 30.

### How to Use Printing Apparatus 100

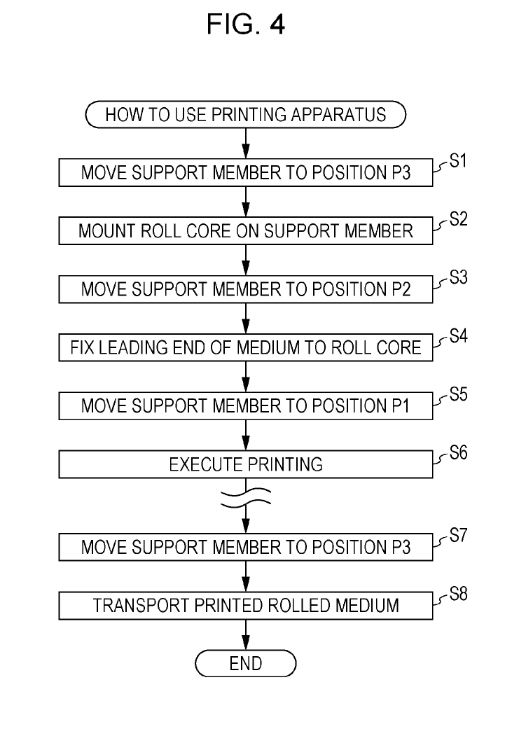

A using method of the printing apparatus 100 configured as above will be described hereunder, focusing on the handling of the roll core C. FIG. 4 is a flowchart showing how to use the printing apparatus 100. Referring to FIG. 4, in an initial state in which the roll core C is not mounted yet, first the user manually operates the moving mechanism 50 so as to move the support member 40 to the position P3 shown in FIG. 3 (S1). The user then mounts the roll core C on the support member 40 located at the position P3 (S2).

After mounting the support member 40 on the roll core C, the user operates the moving mechanism 50 so as to move the support member 40 to the position P2 shown in FIG. 2, from the position P3 (S3). Accordingly, the support member 40 is lifted up from the position P3 and comes close to the printing mechanism 10. Upon setting the support member 40 at the position P2, the user fixes the leading end portion of the medium M drawn out of the unprinted rolled medium 92, to the roll core C supported by the support member 40 (S4). The user may fix the leading end portion of the medium M drawn out through between the printing unit 12 and the main body 14, to the outer circumferential surface of the roll core C for example using an adhesive tape. When the support member 40 is at the position 2 which is close to the printing mechanism 10, the length by which the medium M is drawn out through between the printing unit 12 and the main body 14 (hereinafter, draw-out length) is shorter compared with, for example, the case where the support member 40 is at the position P1 or position P3. Therefore, the leading end portion of the medium M can be easily fixed to the roll core C. When the draw-out length of the medium M is extended, the in-plane stress (tension) of the medium M is more prone to become uneven, and wrinkles are prone to appear on the medium M. In case that the leading end portion of the medium M is fixed to the roll core C in such conditions and the printing is executed by the printing mechanism 10, the printing quality may be degraded. In the first embodiment, since the support member 40 is moved to the position P2 so as to facilitate the leading end portion of the medium M to be fixed to the roll core C with the shorter draw-out length of the medium M, the medium M can be properly fixed to the roll core C, with uniform in-plane stress and free from wrinkles. Therefore, high printing quality can be secured.

After the medium M is fixed to the roll core C through the foregoing process, the user operates the moving mechanism 50 so as to move the support member 40 from the position P2 to the position P1 (S5). Accordingly, the support member 40 is brought down and the roll core C is accommodated in a space under the heater 30. Then the printing mechanism 10 executes the printing on the medium M, while the support member 40 is at the position P1 (S6). The medium M printed by the printing mechanism 10 is wound around the roll core C supported by the support member 40 at the position P1. As described above, the space under the heater 30 can be effectively utilized to store the printed medium M, while images are printed on the medium M. In addition, when the support member 40 is at the position P1, the center of gravity of the printing apparatus 100 is shifted to a lower position, compared with the case where the support member 40 is at the position P2. Therefore, the printing apparatus 100 can be better stabilized.

Here, in the case where the printing mechanism 10 executes the printing while the support member 40 is at the position P2, the medium M is wound around the roll core C immediately after the printing mechanism 10 executes the printing. Accordingly, the ink stuck to the medium M is not sufficiently dried, and also it is difficult for the user to visually confirm the status of the image printed on the medium M by the printing mechanism 10 (e.g., printing defect such as blur of the image). In the first embodiment, in contrast, the printing is executed when the support member 40 is at the position P1. Accordingly, a sufficient distance can be secured before the medium M discharged from the printing mechanism 10 is wound around the roll core C. Therefore, the ink stuck to the medium M can be effectively dried by the heater 30, and also the user can easily confirm visually the status of the image printed on the medium M by the printing mechanism 10. Further, when the support member 40 is at the position P3, the overall size of the printing apparatus 100 is increased in the Y-direction, compared with the case where the support member 40 is at the position P1 or position P2. Accordingly, the work may be disturbed, and a sufficient space may be unable to be secured around the printing apparatus 100. In the first embodiment, since the printing is executed when the support member 40 is at the position P1, such situations that the work is disturbed, and a sufficient space is unable to be secured around the printing apparatus 100 can be avoided.

When the entirety of the medium M in the unprinted rolled medium 92 has undergone the printing operation, the user operates the moving mechanism 50 so as to move the support member 40 from the position P1 to the position P3 shown in FIG. 3 (S7). Upon setting the support member 40 at the position P3, the user removes the printed rolled medium 96, in other words the printed medium M wound around the roll core C, from the support member 40, and transports the printed rolled medium 96 to a desired location (S8). To transport the printed rolled medium 96 removed from the support member 40, a known handcart may be utilized.

As described above, in the first embodiment the support member 40 with the roll core C mounted thereon can be moved to the plurality of positions (P1, P2, and P3). In other words, the position of the roll core C in the Z-direction is variable. Therefore, the roll core C can be moved to such positions that are appropriate for performing various works related to the roll core C. For example, as described above, when the support member 40 is at the position P2, the medium M can be more easily fixed to the roll core C (S4), compared with the case where the support member 40 is at the position P1 or position P3. In addition, causing the printing mechanism 10 to execute the printing while the support member 40 is at the position P1 (S6) allows the space under the printing mechanism 10 to be effectively utilized to store the printed medium M (printed rolled medium 96).

In the first embodiment, further, the support member 40 can be moved to the position P3 on the opposite side of the printing mechanism 10 with respect to the straight line L drawn between the position P1 and the position P2. Therefore, the support member 40 can be prevented from colliding with the heater 30 and the printing mechanism 10, while being moved by the moving mechanism 50. Here, the position P1 may be too low to mount or remove the roll core C on or from the support member 40 (S2, S8). Likewise, the position P2 may be too high to mount or remove the roll core C on or from the support member 40. However, in the first embodiment the roll core C can be mounted or removed when the support member 40 is at the position P3, which is located between the position P1 and the position P2, and therefore the work to mount or remove the roll core C on or from the support member 40 can be easily performed. In the case where, for example depending on the installation condition of the printing apparatus 100, it is easier to mount or remove the roll core C when the support member 40 is at the position P1 or position P2, the support member 40 may be set at the position P1 or position P2, to mount or remove the roll core C.

### Second Embodiment

A second embodiment of the invention will now be described hereunder. The elements referred to hereunder that are the same as those of the first embodiment in working or function will be given the same numeral, and the detailed description of such elements will not be repeated.

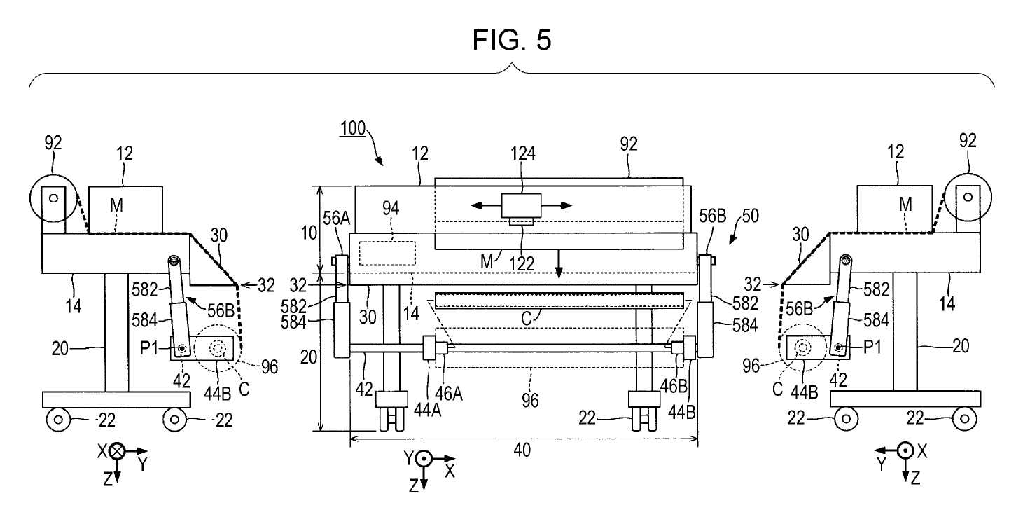

FIG. 5 includes a front view and side views of the printing apparatus 100 according to the second embodiment. As shown in FIG. 5, the printing apparatus 100 according to the second embodiment includes a retaining arm 56A and a retaining arm 56B, in place of the retaining arm 52A and the retaining arm 52B in the printing apparatus 100 according to the first embodiment. The retaining arm 56A is mounted on an end portion of the printing mechanism 10 on the minus side in the X-direction, and the retaining arm 56B is mounted on the other end portion of the printing mechanism 10 on the plus side in the X-direction.

The retaining arm 56A and the retaining arm 56B each include a base portion 582 and a movable portion 584. The base portion 582 is a bar-shaped member having a circular cross-section, and having an end portion pivotally supported by the main body 14 of the printing mechanism 10. The base portion 582 is pivotable in the Y-Z plane about an axial line parallel to the X-direction. The movable portion 584 is cylindrical member in which the base portion 582 is inserted. The relative positional relationship between the movable portion 584 and the base portion 582 in a direction along the respective central axes of the retaining arm 56A and the retaining arm 56B can be changed, by adjusting the insertion depth of the base portion 582 into the movable portion 584. Accordingly, the total length of each of the retaining arm 56A and the retaining arm 56B is variable (stretchable). The end portion of the support shaft 42 of the support member 40 on the minus side in the X-direction is supported by the movable portion 584 of the retaining arm 56A, and the other end portion of the support shaft 42 on the plus side in the X-direction is supported by the movable portion 584 of the retaining arm 56B.

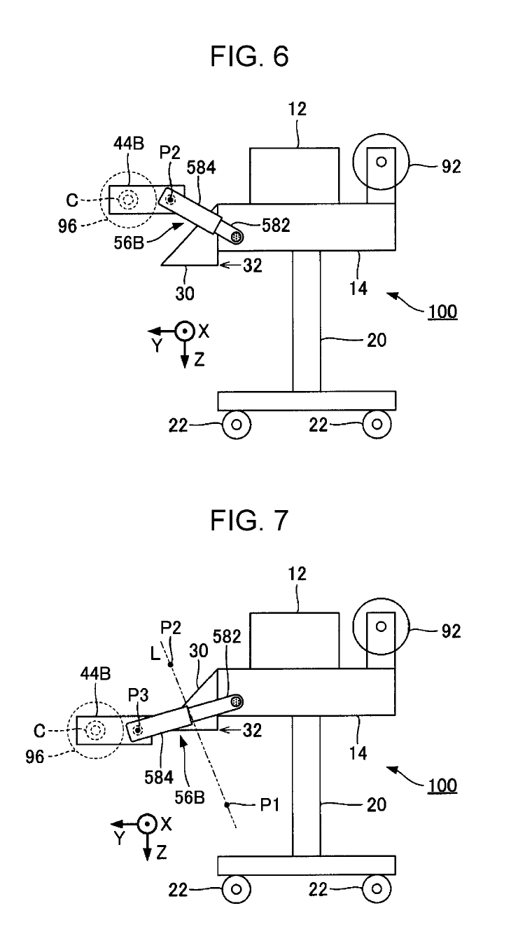

The user can manually adjust the angle of the base portion 582 and the position (insertion depth) of the base portion 582 relative to the movable portion 584, with respect to each of the retaining arm 56A and the retaining arm 56B, so as to change the position of the support member 40. Accordingly, the moving mechanism 50 according to the second embodiment, including the retaining arm 56A and the retaining arm 56B, can move the support member 40 to a plurality of positions, as in the first embodiment. More specifically, the moving mechanism 50 according to the second embodiment can also move the support member 40 to the position P2 shown in FIG. 6 and the position P3 shown in FIG. 7, not only to the position P1 shown in FIG. 5.

As in the first embodiment, the position P1 shown in FIG. 5 is lower than the heater 30, and the position P2 is higher than the position P1 as shown in FIG. 6. The position P3 is, as shown in FIG. 7, located between the position P1 and the position P2, in the Z-direction. To be more detailed, the position P3 is located on the opposite side of the printing mechanism 10 with respect to the straight line L drawn between the position P1 and the position P2, in a view in a direction parallel to the central axis of the roll core C (i.e., X-direction). Therefore, as in the first embodiment, when the support member 40 moves from one of the positions P1 and P2 to the other, the support member 40 passes the position P3 spaced from the straight line L, so as to circumvent the heater 30.

The printing apparatus 100 may be utilized in the same way as in the first embodiment (FIG. 4). The roll core C is mounted on the support member 40 when the support member 40 is at the position P3 shown in FIG. 7 (S1, S2), and after the support member 40 is moved from the position P3 to the position P2 shown in FIG. 6, the leading end portion of the medium M is fixed to the roll core C (S3, S4). Then the support member 40 is moved from the position P2 to the position P1 shown in FIG. 5, after which the printing mechanism 10 executes the printing (S5, S6). When the entirety of the medium M has been printed, the support member 40 is moved from the position P1 to the position P3 and then the printed rolled medium 96 is removed from the support member 40 and transported to a desired location on a handcart (S7, S8). As may be apparent from the foregoing description, the second embodiment also provides the same advantageous effects as those provided by the first embodiment.

### Third Embodiment

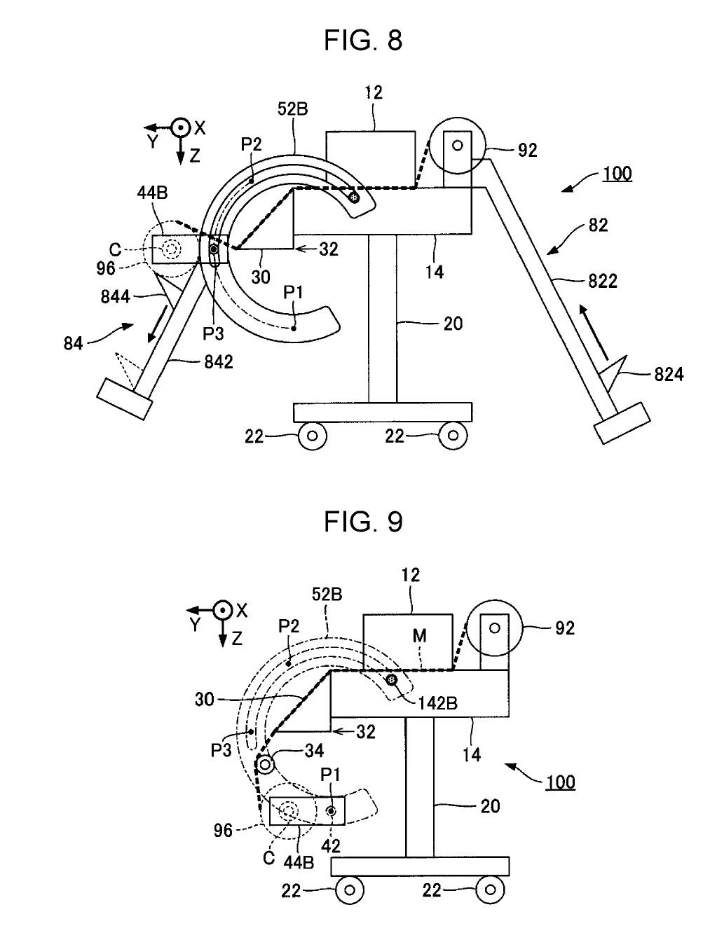

FIG. 8 is a side view of the printing apparatus 100 according to a third embodiment. As shown in FIG. 8, the printing apparatus 100 according to the third embodiment further includes a transport device 82 and a transport device 84, in addition to the configuration of the first embodiment. The transport device 82 is used to lift up the unprinted rolled medium 92, and the transport device 84 is used to bring down the printed rolled medium 96. The transport device 82 includes a transport path 822 and a moving piece 824. The transport device 84 includes a transport path 842 and a moving piece 844. The transport path 822 and the transport path 842 each have a rail-shaped structure inclined with respect to the vertical direction (Z-direction). The moving piece 824 is movable along the transport path 822, with the end portions of the roll core C of the unprinted rolled medium 92 supported thereon. The moving piece 844 is movable along the transport path 842, with the end portions of the roll core C of the printed rolled medium 96 supported thereon. The moving piece 824 and the moving piece 844 may each be driven by force supplied from, for example, a non-illustrated drive source such as a motor.

The user mounts the unprinted rolled medium 92 transported on the handcart on the moving piece 824, and lifts up the moving piece 824. When the unprinted rolled medium 92 reaches the uppermost position of the transport path 822, the user sets the unprinted rolled medium 92 on the main body 14 of the printing mechanism 10. When the entirety of the medium M has been printed, the user moves the printed rolled medium 96 from the position P1 to the position P3 (S7), and mounts the printed rolled medium 96 on the moving piece 844 of the transport device 84, from the position P3. Then the user brings down the moving piece 844, with the printed rolled medium 96 supported thereon as described above (S8). When the printed rolled medium 96 reaches the lowermost position of the transport path 842, the user transports the printed rolled medium 96 on the handcart, to a desired location.

In the third embodiment, the transport device 82 for lifting up the unprinted rolled medium 92 and the transport device 84 for bringing down the printed rolled medium 96 are provided. Therefore, the burden in the mounting work of the unprinted rolled medium 92 and the removing work of the printed rolled medium 96 can be reduced. Here, although the foregoing description refers to the case where the transport device 82 and the transport device 84 are added to the configuration of the first embodiment, the transport device 82 and the transport device 84 may be added to the configuration of the second embodiment. Further, only either of the transport device 82 and the transport device 84 may be provided.

### Variation

In the foregoing embodiments, the medium M printed by the printing mechanism 10 is brought into contact with the heater 30. However, elements with which the printed medium M may make contact before being wound around the roll core C (medium outlet) are not limited to the heater 30. For example, as shown in FIG. 9, a discharge roller 34 may be provided downstream of the printing mechanism 10 in the transport direction of the medium M (e.g., downstream of the heater 30). The rotary shaft of the discharge roller 34 is parallel to the X-direction. The printed medium M contacts the outer circumferential surface of the discharge roller 34, before being wound around the roll core C. As may be apparent from the foregoing description, the heater 30 and the discharge roller 34 exemplify the medium outlet in the invention, provided downstream of the printing mechanism 10 in the transport direction of the medium M, so as to contact the same. With respect to the medium outlet, the position P1 (exemplifying the first position in the invention) may be collectively expressed as a position lower than the medium outlet (to be more detailed, lower than a lower end portion of the medium outlet). The position P2 (exemplifying the second position in the invention) may be expressed as a position higher than the lower end portion of the medium outlet (e.g., lower end portion of the heater 30).

Although the foregoing embodiments represent the case where the printing apparatus 100 is a serial printer in which the transport member 124 having the liquid ejecting head 122 mounted thereon moves in the X-direction, the invention is also applicable to a line-type printing apparatus in which the plurality of nozzles of the liquid ejecting head are distributed over the entire width of the medium M.

The entire disclosure of Japanese Patent Application No. 2016-190900, filed Sep. 29, 2016 is expressly incorporated by reference herein.

What is claimed is:

1. A printing apparatus comprising:
a printing mechanism configured to execute printing on a medium;
a support member configured to support a roll core around which the medium printed by the printing mechanism is wound; and
a moving mechanism configured to move the support member to a plurality of positions different from each other in height in a vertical direction.

2. The printing apparatus according to claim 1, further comprising a medium outlet located downstream of the printing mechanism in a transport direction of the medium, and formed so as to contact the medium,
wherein the moving mechanism is configured to move the support member to a first position where the roll core is located at a position lower than the medium outlet, and to a second position higher than the first position.

3. The printing apparatus according to claim 2,
wherein the moving mechanism is configured to move the support member to a third position between the first position and the second position in a path along which the moving mechanism moves the support member, the third position being located on an opposite side of the printing mechanism with respect to a straight line drawn between the first position and the second position, in a view in a direction parallel to a central axis of the roll core.

4. The printing apparatus according to claim 1,
wherein the support member includes a support shaft extending in a width direction of the medium; and
a first mounting guide and a second mounting guide attached to the support shaft,
wherein the first mounting guide and the second mounting guide support respective end portions of the roll core, and
the support shaft is located at a position other than right under the roll core.
